(19) United States
(12) Patent Application Publication
(10) Pub. No.: US 2018/0288508 A1
(43) Pub. Date: Oct. 4, 2018

(54) Speaker Grill and Speaker

(71) Applicant: Bose Corporation, Framingham, MA (US)

(72) Inventors: Peter C. Santoro, Groton, MA (US); Robert A. Warden, Southborough, MA (US)

(73) Assignee: Bose Corporation, Framingham, MA (US)

(21) Appl. No.: 15/471,602

(22) Filed: Mar. 28, 2017

(51) Int. Cl. H04R 1/02

(52) U.S. Cl. CPC H04R 1/023; H04R 2201/021; H04R 1/021

(57) ABSTRACT

A loudspeaker includes a housing, a movable diaphragm within the housing for creating sound waves, and a grill secured to the loudspeaker which covers the diaphragm. At least a substantial portion of a perimeter of the grill has a peripheral region which is folded back on itself by an angle greater than about 95 degrees.

### BACKGROUND

This disclosure relates to a speaker grill and a speaker to which the grill can be secured.

Conventional speakers which are designed to be mounted in a wall, ceiling or floor often stand somewhat proud of the surface into which they are mounted. This results in a speaker which is more visible and not as cleanly integrated into the surface to which the speaker is mounted. Sometimes a bezel on a peripheral region of a speaker grill can buzz or rattle, causing undesirable sounds. Further, when the grill is magnetically secured to the speaker, the arrangement of the bezel and peripheral region of the grill can make it challenging to get a finger under the bezel to remove the grill from the speaker (e.g. for maintenance or inspection).

### SUMMARY

In general, in one aspect, a loudspeaker includes a housing, a movable diaphragm within the housing for creating sound waves, and a grill secured to the loudspeaker which covers the diaphragm. At least a substantial portion of a perimeter of the grill has a peripheral region which is folded back on itself by an angle greater than about 95 degrees.

Implementations may include one or more of the following, in any combination. Substantially all of the perimeter of the grill has a peripheral region which is folded back on itself by an angle greater than about 95 degrees. The peripheral region of the grill is folded back on itself by an angle greater than about 100 degrees. The peripheral region of the grill is folded back on itself by an angle between about 110 degrees and about 225 degrees. The peripheral region of the grill is folded back on itself by an angle between about 120 degrees and about 180 degrees. The peripheral region of the grill is folded back on itself by an angle between about 130 degrees and about than about 170 degrees. The peripheral region of the grill is folded back on itself by an angle between about 140 degrees and about 160 degrees.

In general, in another aspect, a speaker grill includes a piece of material which is substantially acoustically transparent. The piece of material is securable to a speaker housing and able to cover a movable diaphragm, within the housing, for creating sound waves. At least a substantial portion of a perimeter of the grill has a peripheral region which is folded back on itself by an angle greater than about 95 degrees.

Implementations may include one or more of the features in paragraph 4 above in any combination.

In general, in yet another aspect, a loudspeaker includes a housing, a movable diaphragm within the housing for creating sound waves, and a grill secured to the loudspeaker which covers the diaphragm. At least a substantial portion of a perimeter of the grill has a peripheral region which is folded back on itself by an angle greater than about 95 degrees. A portion of the housing and the at least a substantial portion of the peripheral region of the grill are located adjacent to a flat surface to which the loudspeaker is designed to be mounted when the loudspeaker is mounted to the surface.

Implementations may include one or more of the features in paragraph 4 above in any combination.

All examples and features mentioned above can be combined in any technically possible way. Other features and advantages will be apparent from the description and the claims.

### BRIEF DESCRIPTION OF THE DRAWINGS

FIG. 1 shows a perspective view of a loudspeaker;

FIG. 2 shows a perspective view of the loudspeaker of FIG. 1 with a speaker grill removed.

FIG. 3 shows a partial sectional view of a prior art speaker mounted to a flat surface;

FIG. 4 shows a partial sectional view of the loudspeaker of FIGS. 1 and 2 mounted to a flat surface;

FIG. 5 shows a partial sectional view of another speaker grill; and

FIG. 6 shows three ways of folding a peripheral region of a speaker grill back on itself.

### DESCRIPTION

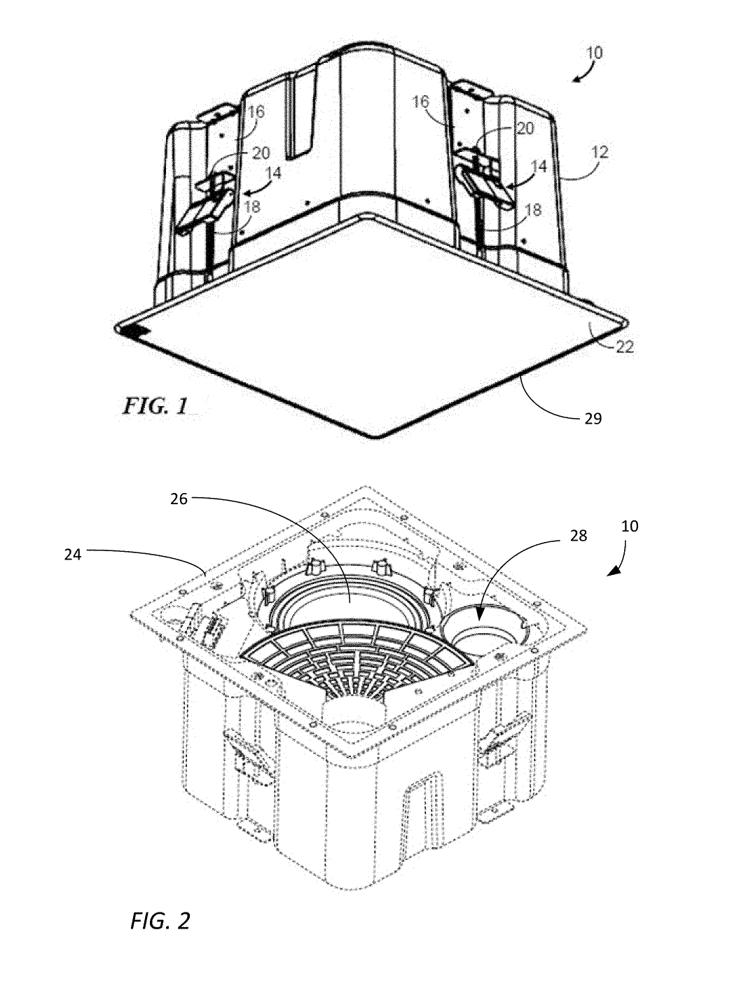

FIGS. 1 and 2 show an example of a ceiling/wall/floor loudspeaker 10 that includes a housing 12 and four mounting devices (only two visible) used to mount the loudspeaker 10 to a flat surface. Each device includes a spring-loaded tab 14, a bracket 16, a threaded rod 18 and a cap nut, or acorn nut, 20.

The loudspeaker 10 includes a rectangular grill 22, but grills of other shapes such as round or square can be used. The grill 22 may be attached to a flange 24 via magnetic connectors on the flange 24 (e.g. if the grill is made of steel) and/or on the side of the grill 22 facing the speaker 10 (e.g. if the flange is made of steel). The grill 22 shields, covers and protects internal system components (e.g. a movable diaphragm 26 for creating sound waves and a port 28) while being substantially acoustically transparent to acoustic signals generated by the speaker system 10.

Acoustic transparency of the grill 22 is provided by a multiplicity of perforations (not shown) through the grill material. These perforations are preferably provided over most of the surface of the grill except for where the grill overlies the flange 24. Instead of having a multiplicity of perforations through a solid material (e.g. metal or plastic) grill 22, the grill can have a more open architecture and be covered with a material such as cloth. At least a substantial portion of a perimeter 29 of the grill has a peripheral region which is folded back on itself (discussed further below). Preferably substantially all of the perimeter of the grill has a peripheral region which is folded back on itself.

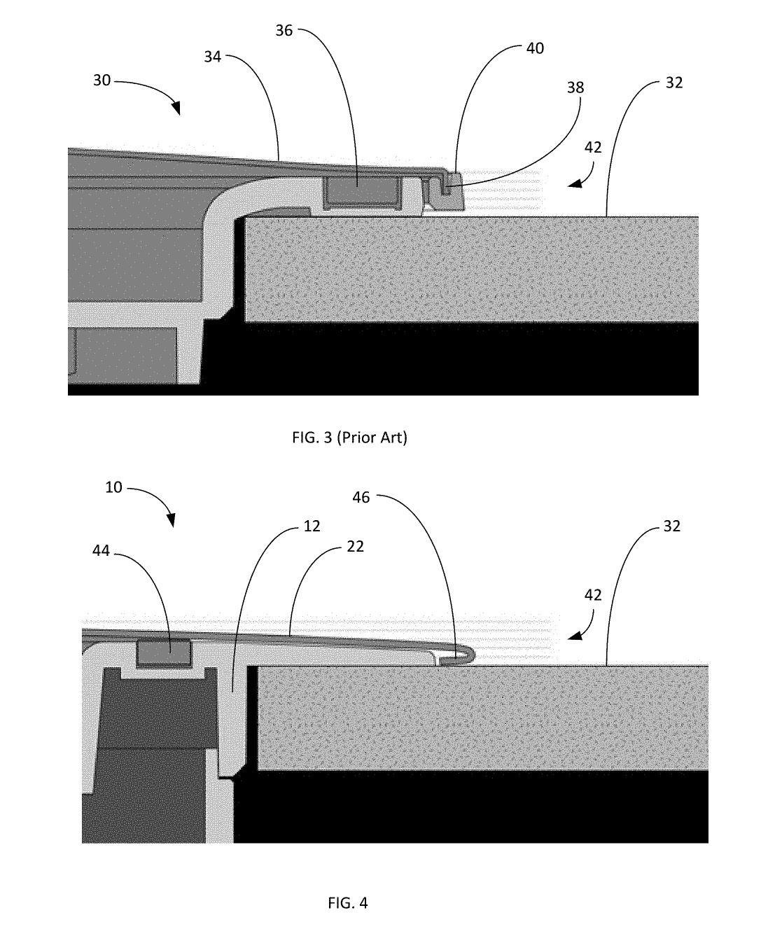

FIG. 3 shows a portion of a prior art speaker 30 mounted to a flat surface 32 (e.g. of a wall or ceiling). A steel grill 34 is secured to the speaker 30 by a permanent magnet 36. A peripheral region 38 of the grill 36 is folded or bent (oriented) by an angle of about 90 degrees. A bezel 40 is placed over the folded portion of the grill. It can be seen that the bezel 40 stands proud of the surface 32 by a distance of about five lines 42.

FIG. 4 shows a portion of the loudspeaker 10 mounted to a flat surface 32 (e.g. of a wall or ceiling) via a housing 12. A steel grill 22 is secured to the speaker 10 by a permanent magnet 44. At least a substantial portion of a perimeter 29 (FIG. 1) of the grill 22 has a peripheral region 46 which is folded or bent (oriented) back on itself by an angle of about 170 degrees. This makes it easier to remove the grill 22 from the speaker as a finger can more comfortably pry the outer round edge of the fold on the grill than can be done on the square corner of the bezel 40. This arrangement eliminates the bezel that is shown in FIG. 3, potentially reducing the amount of buzz or rattle that the speaker 10 might make.

It can be seen in FIG. 4 that the outer edge of the grille 22 stands proud of the surface 32 by a distance of about two lines 42. Thus, the speaker 10 extends a substantially smaller distance away from the surface 32 than does the speaker 30. This can provide a more pleasing appearance of the speaker when mounted. a portion of the housing and the at least a substantial portion of the peripheral region of the grill are located adjacent to a flat surface to which the loudspeaker is designed to be mounted when the loudspeaker is mounted to the surface.

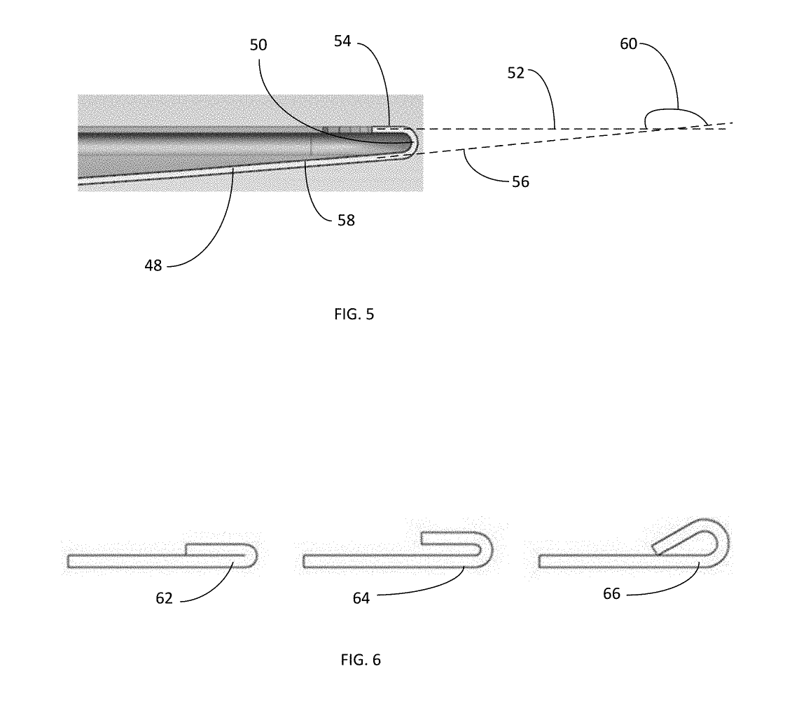

FIG. 5 shows another example of a speaker grill 48 wherein a peripheral region of the grill is folded back on itself by an angle of about 170 degrees. Where the fold 50 is in the shape of a portion of a circle, the angle can be determined by the portion of a circle that the fold sweeps through (e.g. a half circle is 180 degrees). The angle can also be determined by extending a line 52 from a folded back grill portion 54 and a line 56 from the main body 58 of the grill 48, and measuring a larger angle 60 of an intersection of these two lines.

The angle between the folded back and main body portions 54 and 58 of the grill 48 should be greater than about 95 degrees. This angle is preferably greater than about 100 degrees, more preferably between about 110 degrees and about than about 225 degrees, even more preferably between about 120 degrees and about than about 180 degrees, even more preferably between about 130 degrees and about than about 170 degrees, and even more preferably between about 140 degrees and about than about 160 degrees.

FIG. 6 shows three ways of folding a peripheral region of a speaker grill back on itself. Grill 62 is shown with a flat hem type of fold or bend, grill 64 is shown with an open hem type of fold or bend, and grill 66 is shown with a tear drop hem type of fold or bend.

A number of implementations have been described. Nevertheless, it will be understood that additional modifications may be made without departing from the scope of the inventive concepts described herein, and, accordingly, other embodiments are within the scope of the following claims.

What is claimed is:

1. A loudspeaker, comprising:
a housing;
a movable diaphragm within the housing for creating sound waves; and
a grill secured to the loudspeaker which covers the diaphragm, wherein at least a substantial portion of a perimeter of the grill has a peripheral region which is folded back on itself by an angle greater than about 95 degrees.

2. The loudspeaker of claim 1, wherein substantially all of the perimeter of the grill has a peripheral region which is folded back on itself by an angle greater than about 95 degrees.

3. The loudspeaker of claim 1, wherein the peripheral region of the grill is folded back on itself by an angle greater than about 100 degrees.

4. The loudspeaker of claim 1, wherein the peripheral region of the grill is folded back on itself by an angle between about 110 degrees and about 225 degrees.

5. The loudspeaker of claim 1, wherein the peripheral region of the grill is folded back on itself by an angle between about 120 degrees and about 180 degrees.

6. The loudspeaker of claim 1, wherein the peripheral region of the grill is folded back on itself by an angle between about 130 degrees and about than about 170 degrees.

7. The loudspeaker of claim 1, wherein the peripheral region of the grill is folded back on itself by an angle between about 140 degrees and about 160 degrees.

8. A speaker grill, comprising:
a piece of material which is substantially acoustically transparent, the piece of material being securable to a speaker housing and able to cover a movable diaphragm, within the housing, for creating sound waves, wherein at least a substantial portion of a perimeter of the grill has a peripheral region which is folded back on itself by an angle greater than about 95 degrees.

9. The speaker grill of claim 8, wherein substantially all of the perimeter of the grill has a peripheral region which is folded back on itself by an angle greater than about 95 degrees.

10. The speaker grill of claim 8, wherein the peripheral region of the grill is folded back on itself by an angle greater than about 100 degrees.

11. The speaker grill of claim 8, wherein the peripheral region of the grill is folded back on itself by an angle between about 110 degrees and about 225 degrees.

12. The loudspeaker of claim 8, wherein the peripheral region of the grill is folded back on itself by an angle between about 120 degrees and about 180 degrees.

13. The loudspeaker of claim 8, wherein the peripheral region of the grill is folded back on itself by an angle between about 130 degrees and about 170 degrees.

14. The loudspeaker of claim 8, wherein the peripheral region of the grill is folded back on itself by an angle between about 140 degrees and about 160 degrees.

15. A loudspeaker, comprising:
a housing;
a movable diaphragm within the housing for creating sound waves; and
a grill secured to the loudspeaker which covers the diaphragm, wherein at least a substantial portion of a perimeter of the grill has a peripheral region which is folded back on itself by an angle greater than about 95 degrees, and wherein a portion of the housing and the at least a substantial portion of the peripheral region of the grill are located adjacent to a flat surface to which the loudspeaker is designed to be mounted when the loudspeaker is mounted to the surface.

16. The loudspeaker of claim 15, wherein substantially all of the perimeter of the grill has a peripheral region which is folded back on itself by an angle greater than about 95 degrees.

17. The loudspeaker of claim 15, wherein the peripheral region of the grill is folded back on itself by an angle greater than about 100 degrees.

18. The loudspeaker of claim 15, wherein the peripheral region of the grill is folded back on itself by an angle between about 110 degrees and about 225 degrees.

19. The loudspeaker of claim 15, wherein the peripheral region of the grill is folded back on itself by an angle between about 120 degrees and about 180 degrees.

20. The loudspeaker of claim 15, wherein the peripheral region of the grill is folded back on itself by an angle between about 130 degrees and about 170 degrees.
